(19) United States
(12) Patent Application Publication
(10) Pub. No.: US 2021/0107663 A1
(43) Pub. Date: Apr. 15, 2021

(54) ENGINE DEVICE AND METHOD FOR PROVIDING DRIVE POWER FOR AN ELECTRICAL DEVICE FOR PROVIDING ELECTRICAL ENERGY

(71) Applicant: Rolls-Royce Deutschland Ltd & Co KG, Blankenfelde-Mahlow (DE)

(72) Inventor: Guido WORTMANN, Fuerth (DE)

(21) Appl. No.: 16/625,528

(22) PCT Filed: Jun. 18, 2018
(86) PCT No.: PCT/EP2018/066061

§ 371 Date: Dec. 20, 2019

(30) Foreign Application Priority Data
Jun. 30, 2017 (DE) 10 2017 211 117.8

(51) Int. Cl. B64D 27/10; F01D 15/10

(52) U.S. Cl. CPC B64D 27/10; F01D 15/10; B64D 2027/026; F05D 2220/76; B64D 2221/00

(57) ABSTRACT

An engine device, in particular based on a gas turbine, which can preferably be used for a hybrid-electrically driven aircraft. A drive section of the engine device produces an accelerated gas stream, which is further processed in a gas turbine of the engine device in order to generate thrust. The engine device further includes a power turbine section having multiple power turbines for providing drive power for multiple electric generators. The power turbines are designed in such a way that they can be driven solely on account of direct interaction with the accelerated gas stream leaving the gas turbine, i.e. solely by the gas stream itself and in particular not with the aid of a mechanical coupling to one of the moving components of the drive section.

The invention relates to an engine device, in particular based on a gas turbine, which can preferably be used for a hybrid-electrically driven aircraft.

To drive aircraft, such as fixed-wing aircraft or helicopters, as an alternative to the previously common internal combustion engines, concepts based on electric or hybrid-electric drive systems are being investigated and used. Such a hybrid-electric drive system generally has—of course in addition to other components not mentioned here—at least one internal combustion engine and an electric generator coupled mechanically to the internal combustion engine. The internal combustion engine, which as an engine can be based, for example, on a classic gas turbine with compressor, combustion chamber and turbine section, is integrated into the drive system in series or in parallel and, in the example mentioned, drives the electric generator with the aid of a turbine section in the operating state. The generator accordingly in turn provides electrical energy which, depending on the desired use of the generator, can for example be stored in a battery and/or supplied to an electric motor. This electric motor could, for example, be used to drive a propulsion means of the aircraft.

In such a system, the generator for taking power is preferably integrated into the engine. For instance, the comparatively small generators in these applications are coupled via multiple shafts to the high-pressure shaft of the gas turbine. Generators which provide powers of the order of magnitude of several MW are typically placed on the same axis as the engine itself. In principle, the result of this integration and the coupling of the two components implemented in this case is however the problem that if there is a fault present in the generator, the engine or the gas turbine has to be switched off. This consequently leads to a loss of power and to a possibly critical fault for the aircraft. During the electrical operation of an aircraft, a fault in the drive system can result in an aircraft crash, connected in particular with corresponding dangers to passengers and, as a rule, associated with considerable damage.

In hybrid-electric drives, in which the typically permanently excited generator is coupled to the turbine as described, this problem has not yet been considered and also not yet solved. In aircraft with conventional drives, in which an internal combustion engine generates high electrical power for the on-board electronics, multiple generators are connected via clutches and complex, multi-stage gearboxes, to what is known as the high-pressure shaft of the respective engine. It would also be conceivable to couple the generators to the low-pressure shaft. If a fault is present in one of the generators, the latter is separated from the engine via the respective clutch. Such a clutch is also conceivable for large generators, such as are needed in hybrid-electric drives, but the clutch becomes very heavy and large on account of the higher power class, which makes the concept unusable for this application.

It is therefore an object of the present invention to specify an alternative possible way to provide the necessary drive power for one or more electric generators for a hybrid-electric drive, in particular of an aircraft, while avoiding the aforementioned problems.

This object is achieved by the engine device described in claim 1 and by the method described in claim 7. The sub-claims describe advantageous refinements.

A corresponding engine device for driving a vehicle, in particular a hybrid-electric aircraft, and for providing drive power for an electrical device for providing electrical energy has a drive section and a power turbine section. The drive section is designed to provide an accelerated gas stream to generate thrust to drive the vehicle. The power turbine section for providing the drive power for the electrical device has at least a first power turbine. The latter, i.e. its rotor, in turn has a connecting device, i.e. a shaft or at least one device for connecting the rotor of the power turbine to a shaft with which the first power turbine can be coupled mechanically to a first electrical generator, i.e. to the rotor of the latter, of the electrical device to drive said generator. Each of the power turbines of the power turbine section is formed and arranged in such a way that it can be driven on its own on account of direct interaction with the accelerated gas stream. The formulation “on its own on account of direct interaction” is intended to express the fact that the driving of the one or more power turbines is carried out only by the gas stream L itself and in particular not with the aid of a mechanical coupling to one of the moving components of the drive section, for example to the shafts of the latter.

The concept on which the invention is based is accordingly to decouple the power turbine section which provides the drive power for driving the electric generators mechanically from the gas turbine and from the shafts of the latter, etc., and to drive them solely with the aid of the accelerated gas stream.

The electrical device is formed in such a way that electrical energy provided by the electrical device can be supplied to one or more consumers of the vehicle, wherein the consumer is, for example, an electric motor for driving the vehicle and/or a battery for storing and subsequently providing the electrical energy provided by the device. It would also be conceivable for the consumer to be part of an on-board power supply of the vehicle.

The electrical device can comprise the first or one or more further electric generators. Accordingly, multiple electric consumers can be supplied with the electrical energy, wherein in particular it is possible to take account of the fact that different consumers possibly have different requirements with respect to the electrical energy, for example different operating voltages and power classes.

The power turbine section can likewise comprise one or more further power turbines besides the first. The power turbine section can thus, for example, be formed as a turbine with multiple turbine stages, wherein each of the multiple power turbines is implemented as one of the turbine stages. Alternatively, separate power turbines can be provided.

The power turbines are arranged one after another, as seen in the flow direction of the gas stream, wherein each of the power turbines, i.e. its rotor, has a respective connecting device, i.e. a shaft or at least one device for connecting the rotor of the power turbine to a shaft, with which the respective power turbine can be coupled mechanically to a respective electric generator, i.e. to the rotor of the latter, to drive said generator. There are thus multiple independent systems each comprising a power turbine and a generator, which firstly ensures redundancy of the system and/or, as already indicated, opens up the possibility of supplying different types of electric consumers.

In the power turbine section, a dedicated power turbine is provided in particular for each electric generator, wherein one of these power turbines is respectively coupled mechanically to respectively one of the electric generators. Provision is accordingly made that, for each generator, there is a dedicated power turbine, in order thus to create maximum independence.

In a method for providing drive power for an electrical device for providing electrical energy for a consumer of a vehicle, in particular a hybrid-electric aircraft, it is possible to fall back on the engine device described. The drive section of the engine device provides the accelerated gas stream L and said accelerated gas stream L is led to the first power turbine of the power turbine section. The accelerated gas stream interacts directly with the first power turbine and drives the latter as a result. The first power turbine, thus directly driven in particular on its own by the gas stream L, subsequently provides at least part of the drive power for the electrical device or for the respective generator.

The first electric generator is driven by utilizing the drive power provided by the first power turbine and, in turn, thus provides at least part of the electrical energy for the consumer.

The electrical device can comprise one or more further electric generators in addition to the first generator. Likewise, the power turbine section can comprise one or more further power turbines in addition to the first power turbine. Each of the power turbines is thus assigned to one of the electric generators, wherein the accelerated gas stream L interacts directly with each of the power turbines and drives the latter, and each of the power turbines thus driven directly with the gas stream L provides at least part of the drive power to the electric generator assigned thereto.

Further advantages and embodiments can be gathered from the drawings and the corresponding description.

In the following, the invention and exemplary embodiments will be explained in more detail by using the drawings. There, identical components in different figures are identified by identical designations.

In the drawing:

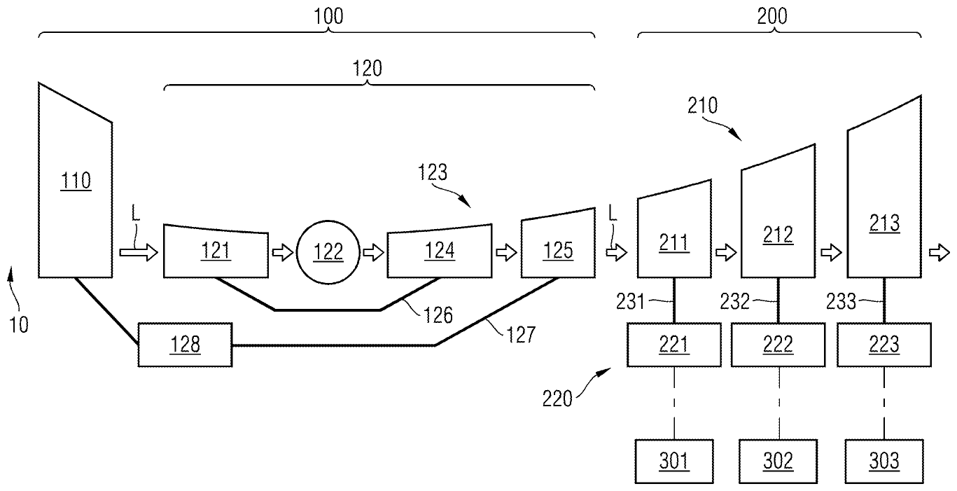

FIG. 1 shows a schematic representation of an engine according to the invention with electric generator coupled thereto.

It should be noted that terms such as “axial”, “radial”, “tangential”, etc. refer to the shaft or axis used in the respective figure or in the respectively described example. In other words, the directions axial, radial, tangential always refer to an axis of rotation of the rotor. “Axial” describes a direction parallel to the axis of rotation, “radial” describes a direction orthogonal thereto, toward the latter or else away from the latter, and “tangential” is a movement or direction which is directed circularly about the axis of rotation at constant radial distance from the axis of rotation and in a constant axial position.

Furthermore, it should be mentioned as a precaution that in the following text, for the purpose of simplification, it will be increasingly mentioned that, for example, a turbine rotates or that it is set rotating, that a turbine is connected via a shaft to a further component or to a compressor or to a generator, that a turbine is driven, that a turbine in turn drives a component, for example a generator, and so on. Of course, this always means that in each case it is not the turbine as such which rotates, etc., but that the respective activity is carried out by a rotor of the respective turbine or that the respective property applies to such a rotor of the turbine. For instance, it is not the turbine itself that is set rotating but of course its rotor and, for example, it is not the turbine as a whole that is connected via a shaft to a generator but the rotor that is connected via the shaft to the generator. Despite this simplification, it is to be assumed from the wording that it is clear to those skilled in the art that, as described, the explanations each relate to the rotor of the turbine.

FIG. 1 shows, schematically and in simplified form, an engine 1, which can be used in an aircraft, for example in a fixed-wing aircraft, to drive the same. The engine 1 is illustrated and oriented here in such a way that, in the operating state, an air or gas stream L flows through the same from left to right, so that in operation it produces thrust directed to the left, which would cause a movement of the engine 1 and the aircraft, not illustrated, to the left.

The engine 1 has a drive section 100. This comprises a fan 110, which is arranged at an inlet 10 of the engine 1, at which air is sucked into the engine 1. The fan 110 accelerates the air sucked in in the axial direction, so that said air is supplied to a gas turbine 120 of the engine 1.

The gas turbine 120 has a high-pressure compressor 121 and a combustion chamber 122 and a turbine section 123. The air L accelerated by the fan 110 firstly reaches the high-pressure compressor 121, which compresses the L supplied thereto. The air thus compressed then reaches the combustion chamber 122, in which fuel, for example kerosene, is supplied to the compressed air supplied. The fuel-air mixture is burned in the combustion chamber 122, which leads to an intense temperature increase and corresponding pressure and volume enlargement of the gas, resulting in a high acceleration of the air or gas stream L out of the combustion chamber 122.

After the combustion chamber 122, i.e. downstream, there follows the turbine section 123 of the gas turbine 120 which, for example, has a high-pressure turbine 124 and a low-pressure turbine 125.

The gas expelled from the combustion chamber 122 firstly reaches the high-pressure turbine 124, which is accordingly set rotating. The high-pressure turbine 124 is connected mechanically via a shaft 126 to the compressor 121, so that the high-pressure turbine 124 can drive the compressor 121 via the shaft 126.

The gas partly expanded in the high-pressure turbine 124 then reaches the low-pressure turbine 125 and drives the latter and sets it rotating. The low-pressure turbine 125 is in turn connected mechanically via a shaft 127 to the fan 110, so that the low-pressure turbine 125 can drive the fan 110 via the shaft 127. Depending on the configuration of the overall system, the low-pressure turbine 125 can also be coupled to the fan 110 via an optional gearbox 128.

The engine 1 described thus far and its function corresponds substantially to the prior art, for which reason the presentation of further details is omitted.

In addition to the familiar components, the engine 1 described here has a device 200 for providing electrical energy for one or more electric consumers 301, 302, 303 of the aircraft. The consumers 301, 302, 303 can be, for example, an electric motor for driving the aircraft, an on-board power supply of the aircraft and/or a battery for the temporary storage of the electrical energy provided.

The device 200 comprises a power turbine section 210 having at least one power turbine 211, but preferably, and accordingly illustrated in FIG. 1, with multiple power turbines 211, 212, 213. The power turbines 211, 212, 213 are arranged downstream of the turbine section 123, so that the gas stream L leaving the turbine section 123 or the low-pressure turbine 125 of the latter flows to and through the power turbines 211, 212, 213 one after another and, as a result, sets them each rotating and drives them, so that they can in turn each provide drive power for components connected downstream. The power turbines 211, 212, 213 can be formed here as separate power turbines or else as turbine stages 211, 212, 213 of a common, larger power turbine 210.

In addition, the device 200 comprises a generator section 220 having at least one electric generator 221, but preferably having multiple electric generators 221, 222, 223. Ideally, the number of generators in the generator section 220 corresponds to the number of power turbines in the power turbine section 210. The generators 221, 222, 223 each operate in a manner known per se, i.e. each generator 221, 222, 223 has, for example, a stator with stator coils and a rotor with permanent magnets. The coils and the magnets can interact electromagnetically with one another, so that as the rotor rotates, electric voltages are induced in the coils. These can be tapped off as electrical energy from the respective generator at appropriate electric contacts.

Each of the power turbines 211, 212, 213 is connected via a respective shaft 231, 232, 233 to exactly one of the generators 221, 222, 223, so that the drive power provided by the turbines 211, 212, 213 can be provided to the respective generator 221, 222, 223 via the respective shaft 231, 232, 233. Accordingly, a respective power turbine 211, 212, 213 drives the generator 231, 232, 233 connected thereto via the shaft of the latter, so that the driven generator 231, 232, 233 provides electrical energy for the consumers 301, 302, 303 in the manner indicated above. Accordingly, each generator 231, 232, 233 is assigned a separate power turbine 211, 212, 213.

In the configurations described, it proves to be advantageous that the generators 221, 222, 223 are each driven via independent turbines 211, 212, 213, i.e. with the aid of turbines 211, 212, 213, which are in particular not coupled to one of the shafts 126, 127 of the drive section 100 of the engine 1, which ultimately ensure the drive of the aircraft. Although the power turbines 211, 212, 213 are driven by the gas stream L accelerated by the fan 110 and/or by the gas turbine section 120, there is no mechanical coupling to the drive section 100. The drive of the power turbines 211, 212, 213 is accordingly carried out exclusively on account of the direct interaction of the gas stream L with the turbines 211, 212, 213 or with the rotors and turbine blades of the latter. The power turbines 211, 212, 213 are therefore, of course apart from, for example, mountings on a housing of the engine 1, etc., not mechanically connected to the remaining components of the engine 1 that are relevant to the drive of the aircraft. The power turbines 211, 212, 213 are driven via the gas stream leaving the turbine section 123 and—for the case in which the engine 1 is formed as a bypass engine—are driven via the corresponding bypass stream.

For simplicity, the power turbine section 210 comprises only three power turbines 211, 212, 213. However, it is clear that more or fewer than three power turbines can also be provided. The same is true of the generator section 220.

1. An engine device for driving a vehicle, in particular a hybrid-electric aircraft, and for providing drive power for an electrical device for providing electrical energy, having
a drive section which is designed to provide an accelerated gas stream L for generating thrust for driving the vehicle,
a power turbine section for providing the drive power for the electrical device, having at least a first power turbine, wherein the first power turbine has a connecting device, with which the first power turbine can be coupled mechanically to a first electric generator of the electrical device to drive said generator,
wherein
each of the power turbines of the power turbine section is formed and arranged in such a way that it can be driven on account of direct interaction with the accelerated gas stream L.

2. The engine device according to claim 1, wherein the electrical device is formed in such a way that electrical energy provided by the electrical device can be supplied to a consumer of the vehicle, wherein the consumer is an electric motor for driving the vehicle or a battery for storing and subsequently providing the electrical energy provided by the device.

3. The engine device according to claim 1, wherein the electrical device comprises the first and at least one further electric generator.

4. The engine device according to claim 1, wherein the power turbine section comprises the first and at least one further power turbine, which are arranged one after another as seen in the flow direction of the gas stream L, wherein each of the power turbines has a respective connecting device, with which the respective power turbine can be coupled mechanically to a respective electric generator to drive said generator.

5. The engine device according to claim 3, wherein in the power turbine section, a dedicated power turbine is provided for each electric generator, wherein in each case one of these power turbines is coupled mechanically to respectively one of the electric generators in order to drive the latter.

6. The engine device according to claim 4, wherein the power turbine section is a turbine with multiple turbine stages, wherein each of the power turbines is implemented as one of the turbine stages.

7. A method for providing drive power for an electrical device for providing electrical energy for a consumer of a vehicle, in particular a hybrid-electric aircraft, by using an engine device for 1) according to claim 1, wherein
the drive section of the engine device provides the accelerated gas stream L, and this accelerated gas stream L is led to the first power turbine of the power turbine section,
the accelerated gas stream L interacts directly with the first power turbine and drives the latter, and
the first power turbine driven directly by the gas stream L provides at least part of the drive power for the electrical device.

8. The method according to claim 7, wherein the first electric generator and is driven by utilizing the drive power provided by the first power turbine, and thus provides at least part of the electrical energy for the consumer.

9. The method according to claim 8, wherein the electrical device comprises the first and at least one further electric generator, and in that the power turbine section comprises the first and at least one further power turbine, wherein each of the power turbines is assigned to one of the electric generators, wherein
the accelerated gas stream L interacts directly with each of the power turbines and drives the latter, and
each of the power turbines thus driven directly with the gas stream L provides the electric generator assigned thereto with at least part of the drive power.
